(19) United States
(12) Patent Application Publication
(10) Pub. No.: US 2023/0419293 A1
(43) Pub. Date: Dec. 28, 2023

(54) CHECKOUT DEVICE AND PROGRAM

(71) Applicant: Toshiba Tec Kabushiki Kaisha, Tokyo (JP)

(72) Inventor: Yasunobu SUZUKI, Nagoya Aichi (JP)

(21) Appl. No.: 18/188,221

(22) Filed: Mar. 22, 2023

(30) Foreign Application Priority Data
Jun. 27, 2022 (JP) 2022-102523

(51) Int. Cl. G06Q 20/22; G06Q 20/20; G06Q 20/34

(52) U.S. Cl. CPC G06Q 20/227; G06Q 20/204; G06Q 20/357

(57) ABSTRACT

According to an embodiment, a checkout device includes a processor configured to acquire an identifier value identifying a customer by member type and then acquire payment method options available to the customer for settlement of a sales transaction according to the identified member type. The processor then causes a display unit to display a selection screen on which the acquired payment method options available to the customer are selectable. The processor may then receive a selection input of a payment method from among the selectable payment method options, then perform settlement using the selected payment method.

### CROSS-REFERENCE TO RELATED APPLICATION

This application is based upon and claims the benefit of priority from Japanese Patent Application No. 2022-102523, filed Jun. 27, 2022, the entire contents of which are incorporated herein by reference.

### FIELD

Embodiments described herein relate generally to a checkout device and a program for a checkout device.

### BACKGROUND

In a store selling products and services (hereinafter collectively referred to as “commodities”), a service for granting privileges to customers who have registered as a member has been implemented in order to improve customer loyalty and the like. For example, the store grants points to a customer who is a member at a predetermined ratio to the amount (value) of the customer's purchases.

In recent years, retailers and stores (hereinafter collectively referred to as “stores”) that operate different member systems associated with limited payment methods (e.g., a store credit or charge card) have also been increasing. In some examples, a store may provide points or other benefits to a member who makes purchase payments by electronic money type operated by the store itself or by cash. Some members may have memberships associated with multiple payment methods and can thus select among a plurality of payment methods. In some examples, a store may run a promotional effort for a payment method type that is particularly advantageous for the store to encourage customers to use such a payment method.

When the store adopts multiple member systems in this manner with the different payment methods associated with each system, a customer may sometimes erroneously select a payment method that has not been set for the customer when the customer inputs a payment method selection to a checkout device. In such a case, an error might be displayed on the checkout device. Thus, operation of the checkout device by the operator (which may be a store clerk or the customer depending on the checkout device type) is increased in complexity and made more burdensome.

### BRIEF DESCRIPTION OF THE DRAWINGS

FIG. 1 is a diagram illustrating an overview of a store system in an embodiment.

FIG. 2 is a block diagram of a point-of-sale (POS) terminal in an embodiment.

FIG. 3 is a diagram illustrating a data configuration of a commodity master stored in a storing unit of a POS terminal.

FIG. 4 is a diagram illustrating a data configuration of a member type management table stored in a storing unit of a POS terminal.

FIG. 5 is a diagram illustrating a data configuration of a payment method management table stored in a storing unit of a POS terminal.

FIG. 6 is a diagram illustrating a data configuration of a selection screen setting table stored in a storing unit of a POS terminal.

FIG. 7 is a block diagram illustrating functional aspects of a control unit of a POS terminal. embodiment.

FIG. 8 is a block diagram of a server device in an

FIG. 9 is a diagram illustrating a data configuration of a member master stored in a storing unit of a server device.

FIG. 10 is a diagram illustrating a data configuration of a point management file stored in a storing unit of a server device.

FIG. 11 is a block diagram illustrating functional aspects of a control unit of a server device.

FIG. 12 is a flowchart of transaction processing by a control unit of a POS terminal.

FIG. 13 is a diagram illustrating an example of a selection screen displayed by a display unit of a POS terminal.

FIG. 14 is a diagram illustrating another example of a selection screen displayed by a display unit of a POS terminal.

FIG. 15 is a flowchart illustrating a flow of transaction processing by the control unit of the POS terminal.

### DETAILED DESCRIPTION

An object of embodiments is to provide a checkout device and a program capable of facilitating operation of an operator.

According to one embodiment, a checkout device includes a processor configured to: acquire an identifier value identifying a customer by member type; acquire payment method options available to the customer for settlement of a sales transaction according to the identified member type; cause a display unit to display a selection screen on which the acquired payment method options available to the customer are selectable; receive a selection input of a payment method from among the selectable payment method options; and perform settlement of the sales transaction using the selected payment method.

A checkout device and a checkout program in certain example embodiments are explained below with reference to the drawings. Embodiments are not limited to the particular example embodiments. For example, in an embodiment explained below, a self-service POS (Point Of Sales) terminal on which a customer performs operations relating to commodity registration and checkout processing is used as one possible example of a checkout device. However, in other examples, the checkout device may be a POS terminal on which a store clerk performs the operations relating to commodity registration and checkout processing, a checkout device of a semi-self-service POS system design in which the store clerk performs operations relating to commodity registration at a registration device and then the customer performs operations relating to checkout processing at a settlement terminal (as a checkout device), or a checkout system in which the customer operates a smartphone or a tablet terminal to register items and perform checkout processing.

In an embodiment, the payment method set for a customer is set based on the member systems to which the customer belongs as a member. That is, payment method is set for customer by member types. However, in other examples, the payment method set for a customer may be set individually set for a customer regardless of the member systems to which the individual customer belongs as a member.

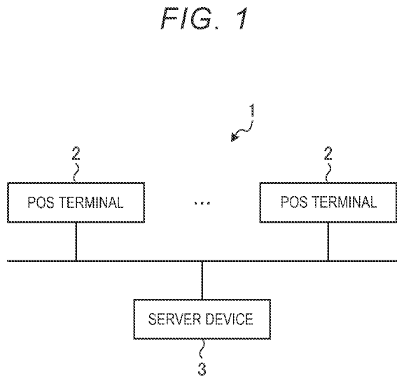

FIG. 1 is a diagram illustrating an overview of a store system 1. The store system 1 in this embodiment can be applied to, for example, a specialty store that mainly sells commodities in a specific genre or class such as apparel or a high-volume retailer such as a supermarket. The store system 1 includes a plurality of POS terminals 2 and a server device 3. The POS terminals 2 and the server device 3 are communicably connected to each other via a network such as a LAN (Local Area Network).

Each of the POS terminals 2 is a self-service POS terminal on which a customer performs operations relating to commodity registration and checkout processing. According to operation of a customer himself or herself who purchases a commodity, the POS terminal 2 reads a commodity code of the commodity to be purchased by the customer and stores commodity information acquired based on the read commodity code to thereby execute the commodity registration. The POS terminal 2 executes the checkout processing based on the information registered by the commodity registration.

The checkout processing is processing for the customer to perform payment and includes calculation processing, settlement processing, and receipt issuance processing. The calculation processing is, for example, calculating a transaction amount (total amount). The settlement processing is processing for completing payment of the transaction amount as calculated by the calculation processing. In cash settlement, the settlement processing includes calculation and dispensing of change. In cashless settlement, the settlement processing includes communication with a settlement server or the like. The receipt issuance processing is processing for issuing a paper receipt and/or an electronic receipt. The POS terminal 2 is an example of a checkout device.

In the checkout processing, the POS terminal 2 acquires a payment method preset for the customer and displays a selection screen for enabling only the acquired preset method(s) to be selected. For example, the POS terminal 2 acquires a member type of the customer and displays a payment method set for the member type on the selection screen in a selectable manner. A payment method that is not set for the customer's member type cannot be selected on the selection screen. That is, the POS terminal 2 makes it possible to change the displayed content on the payment method selection screen according to the particular customer's membership(s).

The operator, who is the customer in this example, perform an input on the payment selection screen to select a desired payment method, but only those preset payment methods associated with the customer can be selected at this time. The POS terminal 2 executes settlement processing by the payment method as selected by the operator.

The POS terminal 2 transmits transaction data for the sales transaction to the server device 3 after the checkout processing is completed. The transaction data includes a transaction date and time, a transaction No. (transaction ID), a transaction amount, commodity information of a purchased commodity, and a member ID of the customer.

In the present context, “member type” refers to the customer's membership in any of the different member systems (or programs) operated by the store. For example, an “electronic money member” is member type whose payment methods are limited to payment by electronic money operated by the store or payment by cash. A “cash member” is a member type whose payment method is limited to payment by cash. A “card member” is a member type who can perform payment by one or more types of electronic money as well as payment by one or more credit cards. A privilege granted to the customer can be different depending on the member type. For example, a point conversion rate of the electronic money member who is considered more advantageous for the store may set higher than a point conversion rate for the other member types. In this context, a point has a value equivalent to money and can be used in the next or later shopping transaction at the store. A award of a point is a privilege granted to a member by the store. The store can arbitrarily decide the possible member types and the available payment method(s) set for each member type.

The server device 3 receives the transaction data after settlement from the POS terminal 2 and manages the transaction data. The server device 3 manages, based on the transaction data received from the POS terminal 2, the points or the like granted to the member. The server device 3 updates, as appropriate, a commodity master storing commodity information of the commodities dealt in by the store and transmits the commodity master to the POS terminals 2.

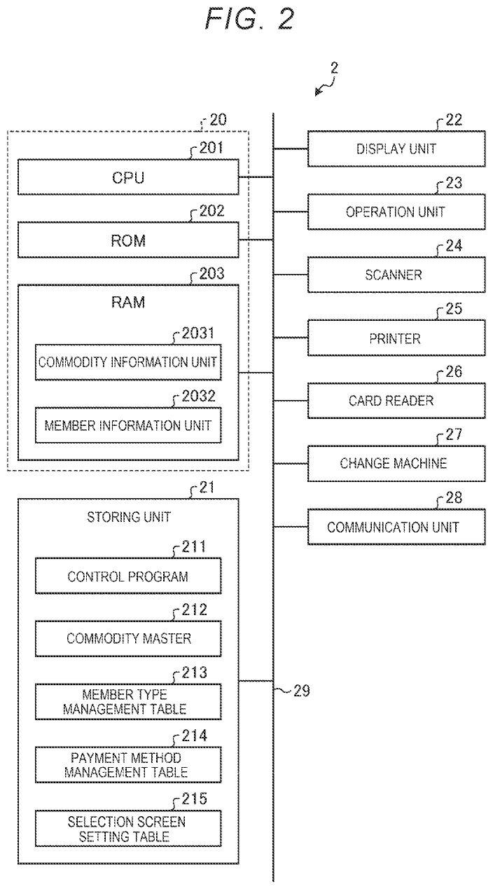

FIG. 2 is a block diagram illustrating a hardware configuration of the POS terminal 2. The POS terminal 2 includes a control unit 20, a storing unit 21, a display unit 22, an operation unit 23, a scanner 24, a printer 25, a card reader 26, a change machine 27, and a communication unit 28. The control unit 20, the storing unit 21, the display unit 22, the operation unit 23, the scanner 24, the printer 25, the card reader 26, the change machine 27, and the communication unit 28 are connected to one another via a bus 29 or the like.

The control unit 20 includes a CPU (Central Processing Unit) 201, a ROM (Read Only Memory) 202, and a RAM (Random Access Memory) 203. The CPU 201, the ROM 202, and the RAM 203 are connected to one another via the bus 29.

The CPU 201 controls the operations of the POS terminal 2. The ROM 202 stores various programs such as a program used to drive the CPU 201 and various data. The RAM 203 is used as a work area of the CPU 201. Various programs and data stored in the ROM 202 and the storing unit 21 are loaded in the RAM 203. The CPU 201 operates according to a control program stored in the ROM 202 or the storing unit 21 and then loaded in the RAM 203, whereby the control unit 20 executes various kinds of control processing for the POS terminal 2.

The RAM 203 includes a commodity information unit 2031 and a member information unit 2032. The commodity information unit 2031 stores commodity information of a commodity purchased by a customer. The commodity information stored by the commodity information unit 2031 is read out from the storing unit 21 based on, for example, a commodity code read by the scanner 24 from a code symbol attached to the commodity. The commodity information stored in the commodity information unit 2031 includes a commodity name and a price. The commodity information being stored (registered) by the commodity information unit 2031 is referred to as commodity registration as well.

The member information unit 2032 stores, if the customer is a member, member information of the customer. The member information stored in the member information unit 2032 is acquired from the server device 3 based on, for example, a member ID read by the scanner 24 from a barcode displayed on a portable terminal of the customer or a member ID read by the card reader 26 from a member card. The member information stored by the member information unit 2032 is a member ID, the number of points owned by the member, and the like. A member type may be stored by the member information unit 2032.

The storing unit 21 is a storage medium such as a HDD (Hard Disk Drive) or a flash memory and maintains stored content even if the POS terminal 2 is turned off. The storing unit 21 stores a control program 211, a commodity master 212, a member type management table 213, a payment method management table 214, and a selection screen setting table 215.

The control program 211 is, for example, a software program for performing commodity registration based on a commodity code read by the scanner 24, a software program for performing checkout processing for a transaction based on information stored by the commodity information unit 2031, a software program for acquiring a member type when the customer is a member, a software program for changing a selection screen according to the acquired member type, and a software program for transmitting and receiving various kinds of information to and from the server device 3.

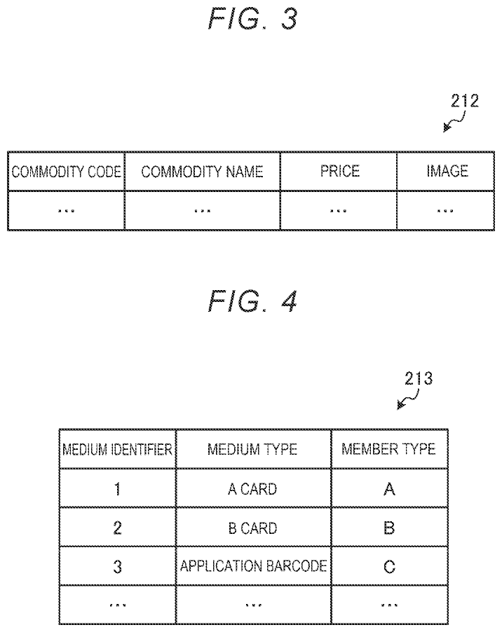

The commodity master 212 is a master file storing commodity information of commodities sold by the store. The commodity master 212 is transmitted from the server device 3 and stored in the storing unit 21. Since commodities dealt in by the store change every day, the commodity master 212 is updated as appropriate. FIG. 3 is a diagram illustrating a data configuration of the commodity master 212. The commodity master 212 stores commodity information in association with a commodity code. The stored commodity information is a commodity name, a price, an image, and the like.

The commodity code is commodity identification information for identifying a commodity. The commodity name is a name of the commodity. The price is a price of the commodity. An amount registered in the price may be either a tax inclusive price or a tax exclusive price. The image is image data indicating the exterior of the commodity.

The member type management table 213 is a table for managing a correspondence relation between a medium that stores a member code (hereinafter simply referred to as “medium” as well) and a member type. In this embodiment, a medium to be used is decided for each of member types. The POS terminal 2 can recognize a member type of the customer by determining a type of a medium. The member type management table 213 is optionally set according to an operation of the store. FIG. 4 is a diagram illustrating a data configuration of the member type management table 213. The member type management table 213 stores a medium type and a member type in association with a medium identifier.

The medium identifier is information for identifying a medium. If a member ID is read from a medium such as a member card or a barcode displayed on a portable terminal of the customer, the medium identifier is read together with the member ID. The medium type is information indicating a type of the medium. The member type is information indicating a member type adopted by the store.

The storing unit 21 does not always have to store the member type management table 213. For example, if the member type of the customer is acquired from the server device 3 based on the member code read by the POS terminal 2, the storing unit 21 does not have to store the member type management table 213.

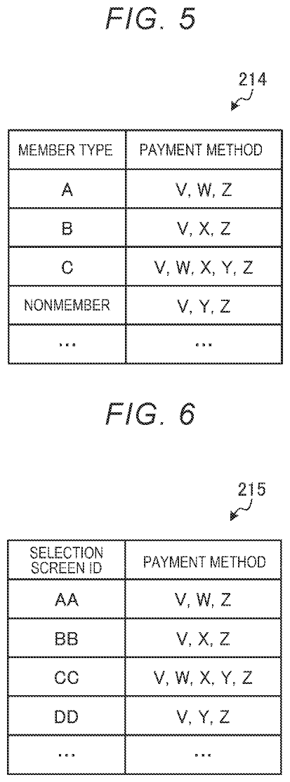

The payment method management table 214 is a table for managing a payment method of the member. The payment method management table 214 is optionally set according to an operation of the store, specifically, a member type decided by the store and a payment method set for the member type. FIG. 5 is a diagram illustrating a data configuration of the payment method management table 214. The payment method management table 214 stores a member type and a payment method in association with each other.

The member type is information indicating the member type adopted by the store as explained above. The payment method is information indicating a payment method for the customer to pay a purchase price and is information indicating, for example, cash payment, electronic money payment, credit card payment, or payment by code settlement.

The selection screen setting table 215 is a table for the operator to set a selection screen for selecting a payment method. The selection screen setting table 215 is optionally set according to an operation of the store. FIG. 6 is a diagram illustrating a data configuration of the selection screen setting table 215. The selection screen setting table 215 stores a selection screen ID and a payment method in association with each other.

The selection screen ID is information for specifying a selection screen displayed on the display unit 22. The selection screen displayed on the display unit 22 is determined by specifying the selection screen ID. In this embodiment, display of an icon of a payment method is different for each of selection screen IDs. As explained above, the payment method is information indicating a payment method for the customer to pay a purchase price.

The commodity master 212, the member type management table 213, the payment method management table 214, and the selection screen setting table 215 may be stored in an external device such as the server device 3 rather than the storing unit 21. In this case, by referring to a commodity master, a member type management table, a payment method management table, and a selection screen setting table stored in the external device, the POS terminal 2 can execute the same processing as processing performed if the commodity master 212, the member type management table 213, the payment method management table 214, and the selection screen setting table 215 are stored in the storing unit 21.

Referring back to FIG. 2, the hardware configuration of the POS terminal 2 is explained.

The display unit 22 is a display device and is configured by a liquid crystal display or the like. The display unit 22 displays various kinds of information under control of the control unit 20. For example, the display unit 22 displays commodity information of a registered commodity, a transaction amount (a total amount of one transaction), and the like. The display unit 22 displays a selection screen for causing the operator to select a payment method.

The operation unit 23 is an input device and is configured by a touch panel provided on the surface of the display unit 22, a keyboard provided separately from the display unit 22, and the like. The operation unit 23 inputs, to the control unit 20, various kinds of information input by operation of the operator. For example, the operation unit 23 inputs, to the control unit 20, a transaction start input for instructing a start of checkout processing. The operation unit 23 inputs, to the control unit 20, a payment method selected on the selection screen.

The scanner 24 reads information from various code symbols shown on media. For example, the scanner 24 reads a commodity code from a commodity barcode attached to a commodity or the like. The scanner 24 reads a member ID and a medium identifier from a barcode displayed on a portable terminal of an application member. The scanner 24 may be a scanner fixedly provided in the POS terminal 2 or may be a handy-type scanner that the operator can take in the operator's hand and operate.

The printer 25 prints and dispenses a receipt relating to one transaction under the control of the control unit 20. The printer 25 prints, on the receipt, transaction information including a transaction amount and the number of granted points and various messages.

The card reader 26 reads information from various cards. For example, the card reader 26 reads customer information necessary for credit card settlement from a credit card of the customer. The card reader 26 reads a member ID and a medium identifier from a member card owned by a card member. The card reader 26 may be a magnetic card reader that reads information from a magnetic card or may be an IC card reader that reads information from a card incorporating an IC chip.

If the customer pays a purchase price by cash, the change machine 27 receives bills and coins paid by the customer and dispenses change according to necessity.

The communication unit 28 is an interface for communicating with an external device such as the server device 3. The control unit 20 becomes capable of transmitting and receiving information (data) to and from the external device by being connected to the external device via the communication unit 28.

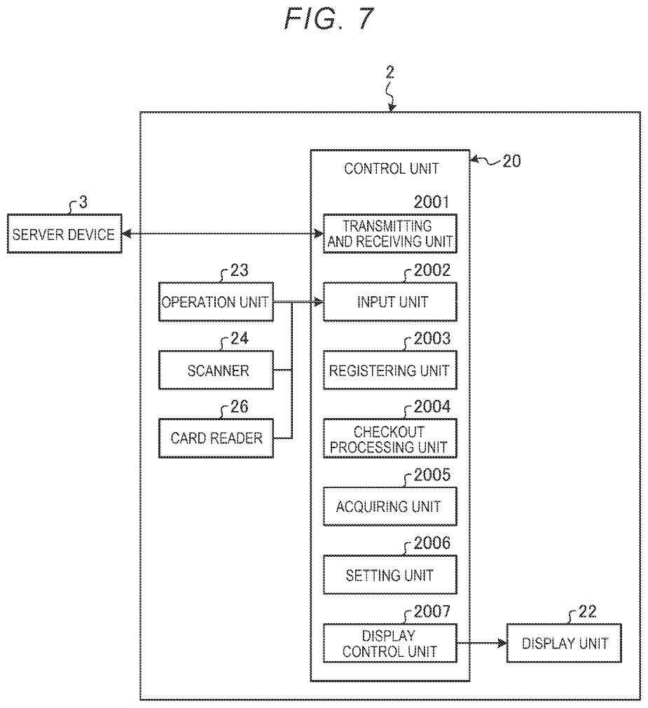

Subsequently, a functional configuration of the control unit 20 of the POS terminal 2 is explained. FIG. 7 is a block diagram illustrating afunctional aspects of the control unit 20 of the POS terminal 2. The CPU 201 operates according to a control program stored in the ROM 202 or the storing unit 21, whereby the control unit 20 functions as a transmitting and receiving unit 2001, an input unit 2002, a registering unit 2003, a checkout processing unit 2004, an acquiring unit 2005, a setting unit 2006, and a display control unit 2007. These functions may be configured using hardware such as a dedicated circuit.

The transmitting and receiving unit 2001 transmits and receives various kinds of information to and from the external device such as the server device 3. For example, the transmitting and receiving unit 2001 transmits, to the server device 3, a member ID input to the input unit 2002. The transmitting and receiving unit 2001 receives member information such as the number of points owned by a member identified by the transmitted member ID. The transmitting and receiving unit 2001 may receive, from the server device 3, a member type as a response to the transmitted member ID.

An identifier of a medium storing customer identification information (a member ID) for identifying a customer is input to the input unit 2002. Specifically, an identifier of a medium read by the scanner 24 from a barcode indicating a member ID or an identifier of a medium read by the card reader 26 from a member card is input to the input unit 2002. The input unit 2002 functions as an identifier input unit.

Customer identification information for identifying a customer who performs a transaction is input to the input unit 2002. Specifically, a member ID is input to the input unit 2002 from the scanner 24 or the card reader 26. The input unit 2002 functions as a customer identification information input unit.

A member type of the customer is input to the input unit 2002. Specifically, the control unit 20 reads out, from the member type management table 213, a member type corresponding to the identifier of the medium input to the input unit 2002. The read-out member type is input to the input unit 2002. A member type received from the server device 3 by the transmitting and receiving unit 2001 based on the member ID input to the input unit 2002 may be input to the input unit 2002.

A commodity code is input to the input unit 2002 from the scanner 24. A transaction start input for instructing a start of checkout processing, a payment method selected by the operator, and the like are input to the input unit 2002.

The registering unit 2003 executes commodity registration. Specifically, the registering unit 2003 reads out, from the commodity master 212, commodity information corresponding to the commodity code input to the input unit 2002 and registers (stores) the commodity information in the commodity information unit 2031. The registering unit 2003 registers the member information received from the server device 3 by the transmitting and receiving unit 2001 in the member type information unit 2032.

The checkout processing unit 2004 executes checkout processing relating to a transaction of commodities. Specifically, the checkout processing unit 2004 calculates a transaction amount of one transaction based on information stored in the commodity information unit 2031. At this time, the checkout processing unit 2004 also calculates a point granted to the member according to the transaction amount. The checkout processing unit 2004 executes settlement processing for causing the member to complete payment of the calculated transaction amount.

The checkout processing unit 2004 performs settlement processing according to the payment method selected on the selection screen. If payment by cash is selected by the operator, the checkout processing unit 2004 deducts a transaction amount from an amount deposited to the change machine 27 to calculate change and causes the change machine 27 to dispense the calculated change. If payment by cashless settlement such as payment by a credit card is selected by the operator, the checkout processing unit 2004 communicates with the settlement server via the transmitting and receiving unit 2001. If the settlement of the transaction is completed, the checkout processing unit 2004 controls the printer 25 to dispense a receipt.

The acquiring unit 2005 acquires a payment method set for the customer who performs the transaction. Specifically, the acquiring unit 2005 reads out, from the payment method management table 214, a (set) payment method associated with the member type input to the input unit 2002 to thereby acquire the payment method. The acquiring unit 2005 may acquire a payment method decided for each of customers. For example, the acquiring unit 2005 may acquire, based on the member ID input to the input unit 2002, a payment method registered for each of members in the server device 3.

The setting unit 2006 sets, based on the payment method acquired by the acquiring unit 2005, a payment method selectable on the selection screen. Specifically, the setting unit 2006 refers to the selection screen setting table 215 and selects a selection screen ID corresponding to the payment method acquired by the acquiring unit 2005. Consequently, the payment method corresponding to the selected selection screen ID is set as the payment method selectable on the selection screen.

The display control unit 2007 causes the display unit 22 to display various kinds of information. For example, the display control unit 2007 causes the display unit 22 to display commodity information of a registered commodity, a transaction amount of one transaction, and the like. The display control unit 2007 causes the display unit 22 to display a selection screen on which the operator can select a payment method.

The display control unit 2007 causes the display unit 22 to display, on the selection screen, an operation element (e.g. a button or icon) for selecting the payment method set by the setting unit 2006 and causes the display unit 22 to display an operation element for selecting a payment method other than the payment method set by the setting unit 2006 in a state in which this operation element cannot be selected (e.g., “grayed out”). For example, the display control unit 2007 causes the display unit 22 to display, on the selection screen, an icon for selecting the payment method set by the setting unit 2006 such that the icon can be operated (selected/pressed). The display control unit 2007 causes the display unit 22 to gray-out display on the selection screen the icon(s) for a payment method other than the payment method set by the setting unit 2006. That is, the payment method(s) not corresponding to those available to the member type are displayed in a non-selectable manner.

The display control unit 2007 may cause the display unit 22 to display, on the selection screen, only the icon for selecting the payment method set by the setting unit 2006. That is, the display control unit 2007 may delete, from the selection screen, the icon for selecting a payment method other than the payment method set by the setting unit 2006.

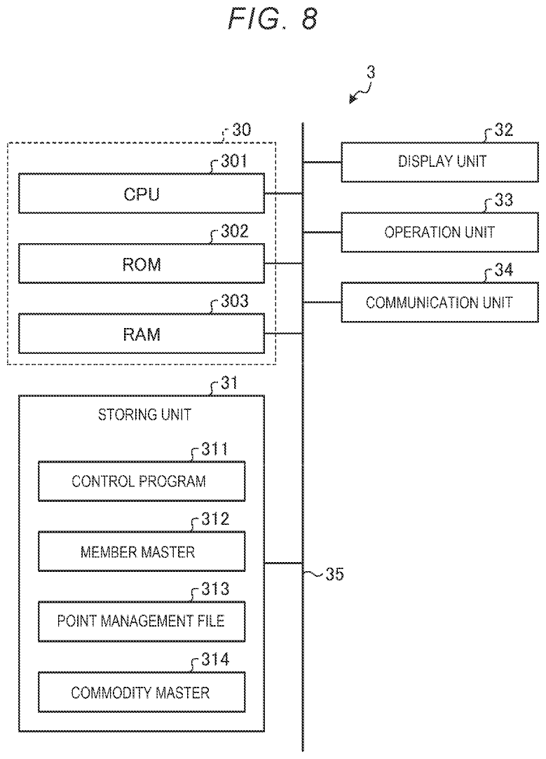

FIG. 8 is a block diagram illustrating a hardware configuration of the server device 3. The server device 3 includes a control unit 30, a storing unit 31, a display unit 32, an operation unit 33, and a communication unit 34. The control unit 30, the storing unit 31, the display unit 32, the operation unit 33, and the communication unit 34 are connected to one another via a bus 35.

The control unit 30 includes a CPU 301, a ROM 302, and a RAM 303. The CPU 301, the ROM 302, and the RAM 303 are connected to one another via the bus 35.

The CPU 301 controls the operations of the server device 3. The ROM 302 stores various programs such as a program used to drive the CPU 301 and various data. The RAM 303 is used as a work area of the CPU 301. Various programs and data stored in the ROM 302 and the storing unit 31 are loaded in the RAM 303. The CPU 301 operates according to a control program stored in the ROM 302 or the storing unit 31 and then loaded in the RAM 303, whereby the control unit 30 executes various kinds of control processing for the server device 3.

The storing unit 31 is a storage medium such as a HDD

or a flash memory and maintains stored content even if the server device 3 is turned off. The storing unit 31 stores a control program 311, a member master 312, a point management file 313, and a commodity master 314.

The control program 311 is, for example, a program for acquiring transaction data from the POS terminal 2, a program for managing a point of a member based on the acquired transaction data, and a program for selecting a member type corresponding to a member ID received from the POS terminal 2 and transmitting the member type to the POS terminal 2.

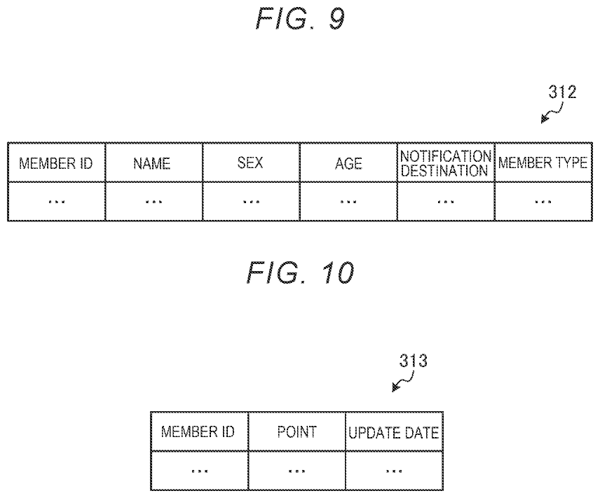

The member master 312 is a master file storing information concerning store members, that is, information concerning customers. FIG. 9 is a diagram illustrating a data configuration of the member master 312. The member master 312 stores a name, sex, age, a notification destination, and a member type in association with a member ID. The notification destination is, for example, a mail address of a portable terminal owned by the member. The member type is information indicating one of the member types adopted by the store.

The point management file 313 is a file for managing a point owned by the member. The point management file 313 is updated based on point information included in transaction data received from the POS terminal 2. FIG. 10 is a diagram illustrating a data configuration of the point management file 313. The point management file 313 stores a point and an update data in association with a member ID. The point is the number of points owned by the member. The update date is a date when a registered point is updated.

Referring back to FIG. 8, the hardware configuration of the server device 3 is explained.

The display unit 32 is configured by, for example, a liquid crystal panel and displays various kinds of information. The display unit 32 displays, according to necessity, for example, information stored in the member master 312, the coupon management file 313, and the commodity master 314.

The operation unit 33 is a unit for inputting information to the control unit 30 and is configured by a keyboard, a touch panel, a mouse, and the like.

The communication unit 34 is an interface for communicating with an external device such as the POS terminal 2. The control unit 30 is connected to the external device via the communication unit 34 to be capable of transmitting and receiving information (data) to and from the external device.

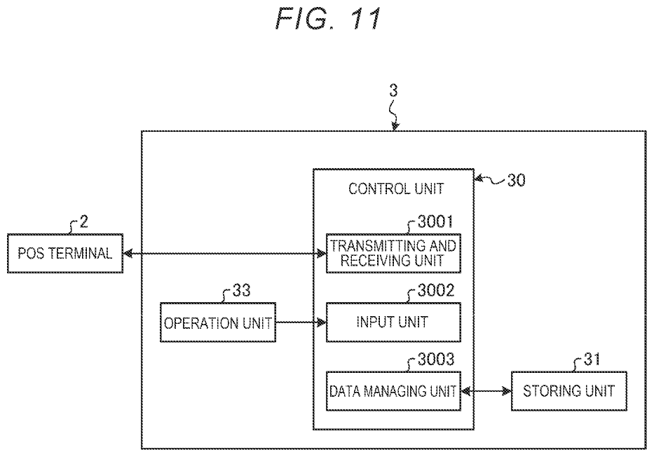

Subsequently, a functional configuration of the control unit 30 of the server device 3 is explained. FIG. 11 is a block diagram illustrating functional aspects of the control unit 30 of the server device 3. The CPU 301 operates according to a control program stored in the ROM 302 or the storing unit 31, whereby the control unit 30 functions as a transmitting and receiving unit 3001, an input unit 3002, and a data managing unit 3003. In some examples, these functions may be configured by hardware such as a dedicated circuit.

The transmitting and receiving unit 3001 transmits and receives various kinds of information to and from the POS terminal 2. For example, the transmitting and receiving unit 3001 receives a member ID of a member who performs a transaction from the POS terminal 2 and transmits member information such as the number of points of the member identified by the member ID to the POS terminal 2. At this time, the transmitting and receiving unit 3001 also transmits a member type of the member identified by the member ID to the POS terminal 2 according to necessity. The transmitting and receiving unit 3001 receives transaction data from the POS terminal 2 at the end of the transaction in this example.

Various kinds of information are input to the input unit 3002 from the operation unit 33. For example, if the member master 312, the point management file 313, and the commodity master 314 are manually updated, information to be updated is input to the input unit 3002.

The data managing unit 3003 registers and updates various data stored in the storing unit 31. The data managing unit 3003 reads out, according to necessity, information stored in the storing unit 31. For example, if the transmitting and receiving unit 3001 receives transaction data from the POS terminal 2, the data managing unit 3003 updates the point management file 313 based on the transaction data. If the transmitting and receiving unit 3001 receives a member ID from the POS terminal 2, the data managing unit 3003 extracts a member type corresponding to the member ID from the member master 312 according to necessity.

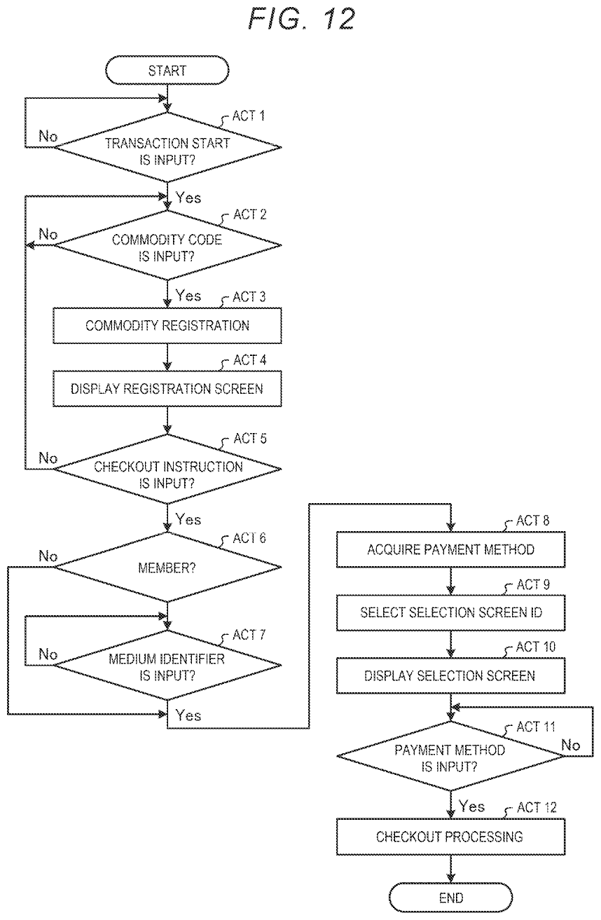

FIG. 12 is a flowchart illustrating transaction processing by the control unit 20 of the POS terminal 2.

The control unit 20 determines whether a transaction start is input to the input unit 2002 (Act 1). If the transaction start is not input (N in Act 1), the control unit 20 returns to the processing in Act 1 and stays on standby.

If the transaction start has been input to the input unit 2002 (Y in Act 1), the control unit 20 next determines whether a commodity code is input to the input unit 2002 (Act 2). If a commodity code has not yet been input (N in Act 2), the control unit 20 returns to the processing in Act 2 and stays on standby.

After a commodity code is input to the input unit 2002 (Y in Act 2), the registering unit 2003 executes commodity registration (Act 3). Specifically, the registering unit 2003 reads out, from the commodity master 212, commodity information corresponding to the commodity code input to the input unit 2002 and stores the commodity information in the commodity information unit 2031.

The display control unit 2007 causes the display unit 22 to display a registration screen (Act 4). The registration screen displays commodity information such as a commodity name, a price, and an image of a registered commodity and displays guidance. The displayed guidance is guidance for informing that reading of commodity barcodes is completed about all commodities to be purchased and an input of a checkout instruction is performed if the commodity barcode reading is completed.

Subsequently, the control unit 20 determines whether a checkout instruction has been input to the input unit 2002 (Act 5). If the checkout instruction is not yet input (N in Act 5), the control unit 20 returns to the processing in Act 2. If the checkout instruction has been input to the input unit 2002 (Y in Act 5), the control unit 20 next determines whether a member is input to the input unit 2002 (Act 6). At this time, the display control unit 2007 causes the display unit 22 to display, for example, a message “Do you have a point card?”, a YES button, and a NO button. If the YES button is operated, the control unit 20 determines that a member indication has been input. If NO button is operated, the control unit 20 determines that a member indication is not input.

If a member indication is input to the input unit 2002 (Y in Act 6), the control unit 20 next determines whether a medium identifier has been provided to the input unit 2002 (Act 7). If a medium identifier is not input (N in Act 7), the control unit 20 returns to the processing in Act 7 and stays on standby.

If a medium identifier is input (Y in Act 7), the acquiring unit 2005 then acquires a payment method (Act 8). Specifically, the acquiring unit 2005 reads out, from the member type management table 213, a member type corresponding to the medium identifier input to the input unit 2002. Subsequently, the acquiring unit 2005 reads out, from the payment management table 214, a payment method corresponding to the readout member type to acquire the available payment methods for the member type.

If the customer is found not to be a member in the processing in Act 6 (N in Act 6), the control unit 20 skips the processing in Act 7 and shifts to processing in Act 8. At this time, the acquiring unit 2005 reads out, from the payment method management table 214, a payment method corresponding to a nonmember to acquire the available payment methods for nonmembers.

Subsequently, the setting unit 2006 selects a selection screen ID to thereby set the payment method(s) selectable on the selection screen (Act 9). Specifically, the setting unit 2006 reads out, from the selection screen setting table 215, a selection screen ID corresponding to the payment method(s) acquired by the acquiring unit 2005.

The display control unit 2007 causes the display unit 22 to display a selection screen specified by the selection screen ID read out by the setting unit 2006 (Act 10). In a state in which the selection screen is displayed, the control unit 20 determines whether a payment method is input to the input unit 2002 (Act 11) and, if a payment method is not input (N in Act 11), returns to the processing in Act 11 and stays on standby.

If a payment method is input (Y in Act 11), the checkout processing unit 2004 executes checkout processing (Act 12). The checkout processing unit 2004 executes the checkout processing according to the payment method input to the input unit 2002. The control unit 20 ends the transaction processing.

With the transaction processing, the POS terminal 2 can cause the display unit 22 to display a selection screen on which only a payment method preset for the customer who performs the transaction is selectable. Consequently, it is possible to prevent a wrong input by the operator and, as a result, improve operability for the operator.

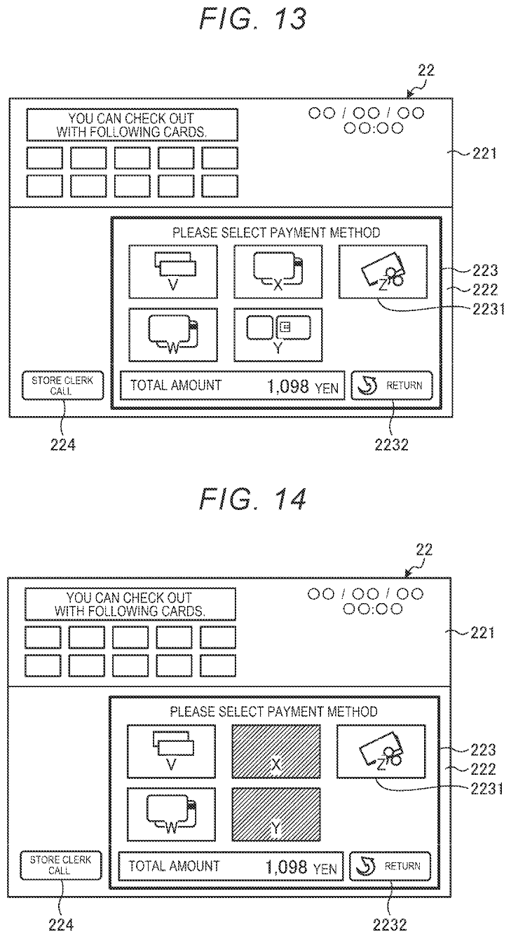

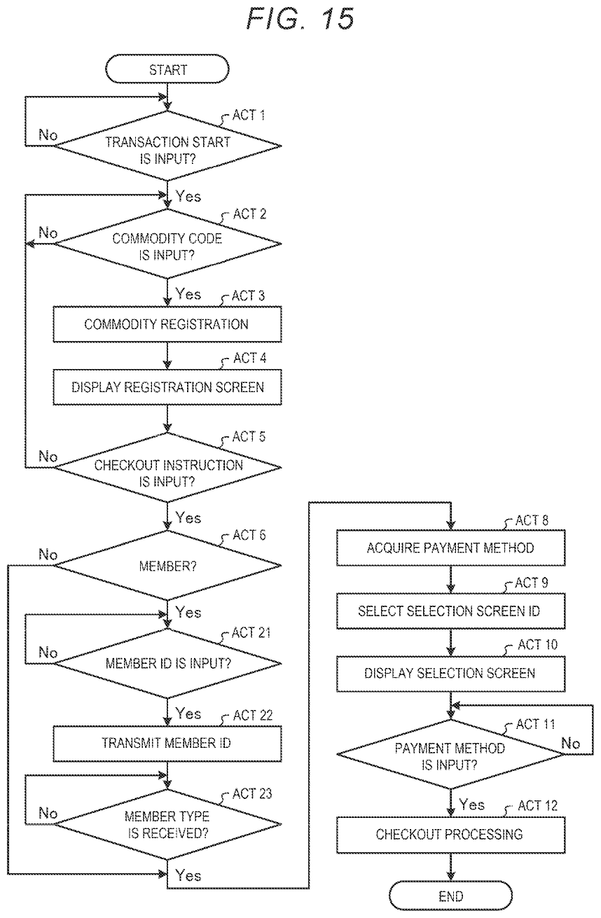

A selection screen displayed by the display unit 22 is explained. FIG. 13 is a diagram illustrating a selection screen displayed by the display unit 22 if the customer is a member of a member type C. FIG. 14 is a diagram illustrating a selection screen displayed by the display unit 22 if the customer is a member of a member type B. In FIGS. 13 and 14, the selection screens include an information display region 221 and a selection display region 222.

A date and time and cashless settlement information are displayed in the information display region 221. The date and time indicates year, month, and day and time at that point in time. The cashless settlement information indicates a type of cashless settlement treated by the store. Specifically, as the cashless settlement information, pluralities of images of credit cards, marks of code settlement, and the like usable in the store are displayed below a message such as “You can check out with the following cards”.

The selection display region 222 is formed as a region for displaying operation buttons and icons operable by the operator. The selection display region 222 includes an icon display section 223 and a store clerk call button 224.

The icon display section 223 displays a plurality of icons 2231 and a return button 2232. The icon display section 223 displays a total amount of commodities purchased by the customer, that is, a transaction amount. The icons 2231 are respectively operation elements indicating payment methods corresponding thereto. The operator can select a payment method by touching any one of the icons. The selected payment method (more accurately, information indicating the selected payment method) is input to the input unit 2002. The return button 2232 is an operation element for returning to the previous screen, for example, an input screen for a member code.

The store clerk call button 224 is an operation element for calling a store clerk. The customer can operate the store clerk call button 224 and call a store clerk if, for example, the customer does not understand operation of the POS terminal 2 or if a trouble occurs at the POS terminal 2 (e.g., an error).

If the customer who performs the transaction is a member type C, since all payment methods V, W, X, Y, and Z available at the store are set for the member type C, on the selection screen illustrated in FIG. 13, icons indicating all possible the payment methods V, W, X, Y, and Z are selectably displayed.

On the other hand, if the customer who performs the transaction is a member of the member type A, since the payment methods V, W, and Z among the payment methods treated by the store are set for the member type A, on the selection screen illustrated in FIG. 14, the icons indicating the payment methods V, W, and Z are selectably displayed and the icons indicating the payment methods X and Y are gray-out displayed such that the icons cannot be operated (selected). Consequently, the operator, who is a member type A, cannot select the icons of the payment methods X and Y, which are not available (set) for the member type A. Accordingly, the operator is prevented from erroneously selecting a payment method that is not set for the member type A.

Since the icons of the payment methods X and Y that cannot be operated are gray-out displayed, the customer, who is the operator, can recognize the other payment methods not set for the customer. Consequently, the customer can consider member registration for a member type capable of performing payment in another payment method not set for the customer. On the selection screen illustrated in FIG. 14, the icons of the payment methods X and Y may be hidden.

A possible modification is now explained. In the embodiment explained above, the member type corresponding to the medium identifier input to the input unit 2002 is read out from the member type management table 213. In this modification, a member type corresponding to a member ID input to the input unit 2002 is instead acquired from the server device 3.

FIG. 15 is a flowchart illustrating a flow of transaction processing by the control unit 20 of the POS terminal 2 in the modification. The same processing as the processing of the treatment processing illustrated in FIG. 12 is denoted by the same sign as the sign illustrated in FIG. 12 and redundant explanation of the processing is omitted.

Processing in Act 1 to Act 6 are the same as the processing illustrated in FIG. 12. If a member is input to the input unit 2002 in the processing in Act 6 (Y in Act 6), the control unit 20 determines whether a member ID is input to the input unit 2002 (Act 21). If a member ID is not input (N in Act 21), the control unit 20 returns to the processing in Act 21 and stays on standby.

If a member ID is input (Y in Act 21), the transmitting and receiving unit 2001 transmits the member ID to the server device 3 (Act 22). Subsequently, the control unit 20 determines whether the transmitting and receiving unit 2001 receives a member type from the server device 3 (Act 23) and, if the transmitting and receiving unit 2001 does not receive a member type (N in Act 23), returns to the processing in Act 23 and stays on standby.

If the transmitting and receiving unit 2001 receives a member ID (Y in Act 23), the acquiring unit 2005 acquires a payment method (Act 8). Specifically, the acquiring unit 2005 reads out, from the payment method management table 214, a payment method (or methods) corresponding to the member type received by the transmitting and receiving unit 2001 to acquire the payment method. The subsequent processing is the same as the processing of the transaction processing illustrated in FIG. 12.

With the transaction processing in this modification, as in the treatment processing illustrated in FIG. 12, the POS terminal 2 causes the display unit 22 to display the selection screen on which only the payment methods set for the customer (member) are selectable. Consequently, it is possible to improve operability for the operator. In the transaction processing in this modification, it is unnecessary to associate the member types to a medium. Accordingly, a plurality of media can be used for the same member type. Therefore, since the customer can select a member type without being restricted by a medium that the customer uses, the store can potentially expand the number of members by improved customer convenience.

The POS terminal 2 in an embodiment includes the display control unit 2007 that causes the display unit 22 to display a selection screen on which a payment method to be used for paying a purchase price of a commodity to be purchased is selectable, the checkout processing unit 2004 that performs settlement with the payment method selected on the selection screen, the acquiring unit 2005 that acquires the payment method(s) set for the customer, and the setting unit 2006 that sets the selectable payment method(s) on the selection screen based on the payment method(s) acquired by the acquiring unit 2005.

Consequently, the POS terminal 2 can cause the display unit 22 to display a selection screen on which the payment method set for the customer who performs the transaction is selectable. Accordingly, by preventing a wrong input of the operator, the POS terminal 2 can prevent occurrence of operation such as error release. Therefore, the POS terminal 2 can facilitate operation of the operator.

In the POS terminal 2 in the embodiment, the display control unit 2007 causes the display unit 22 to display an operation element for selecting the payment method(s) set by the setting unit 2006 in an operator selectable manner and causes the display unit 22 to display an operation element for the payment method(s) other than set by the setting unit 2006 in a manner that indicates the operation element(s) cannot be selected.

Consequently, the POS terminal 2 can cause the operator to recognize the payment methods which are not available to the customer who performs the transaction.

The POS terminal 2 in the embodiment also further includes the input unit 2002 to which a member type of the customer can be input. The acquiring unit 2005 acquires the payment method(s) associated with the member type input to the input unit 2002.

Consequently, the POS terminal 2 can set (preset) payment methods available to the customer by member types. Accordingly, since the store does not need to register a payment method for each of the individual customers, the POS terminal 2 can facilitate an operation of a member service by the store. Since management of the available payment methods for the customer can be performed based on member type that has been set in the store, the POS terminal 2 can facilitate the operation of a member service by the store.

The POS terminal 2 in the embodiment further includes the identifier input unit (the input unit 2002) to which an identifier corresponding to the medium storing the member ID used for identifying the customer is input. A member type associated with the identifier input to the identifier input unit can be input to the input unit 2002.

Consequently, the POS terminal 2 can acquire a member type based on the medium identifier. Accordingly, since the POS terminal 2 can acquire a member type using a medium for reading customer identification information, the POS terminal 2 can easily acquire the member type simultaneously with the reading of the customer identification information.

The POS terminal 2 further includes the customer identification information input unit (the input unit 2002) to which a member ID for identifying the customer can be input. A member type associated with the member ID input to the customer information input unit can be input to the input unit 2002.

Consequently, the POS terminal 2 can easily manage a payment method for the customer even if a plurality of media types are used for the same member type. Accordingly, since the customer can select a member type without being restricted by the medium that the customer uses, the POS terminal 2 can contribute to expansion in the number of members.

In an embodiment, the control programs executed by the POS terminal 2 and the server device 3 may be provided by being recorded in a computer-readable recording medium such as a CD-ROM. The control programs executed by the devices may be stored on a computer connected to a network such as the Internet and may be provided by being downloaded through the network. Further, the control programs may be accessed through a network such as the Internet.

While the embodiment of the present disclosure is explained above, the embodiment is presented as an example and is not intended to limit the scope of the invention. The embodiment can be implemented in other various forms. Various omissions, substitutions, and changes can be made without departing from the gist of the invention.

What is claimed is:

1. A checkout device, comprising:
a processor configured to:
acquire an identifier value identifying a customer by member type;
acquire payment method options available to the customer for settlement of a sales transaction according to the identified member type;
cause a display unit to display a selection screen on which the acquired payment method options available to the customer are selectable;
receive a selection input of a payment method from among the selectable payment method options; and
perform settlement using the selected payment method.

2. The checkout device according to claim 1, wherein a plurality of payment method options for settlement of sales transactions are possible with the checkout device, but the payment method options available to customer for settlement of the sales transaction according to the identified member type is less than all of the plurality of payment method options.

3. The checkout device according to claim 2, wherein the selection screen includes selectable operation elements for the acquired payment method options available to the customer.

4. The checkout device according to claim 3, wherein the selection screen includes non-selectable operation elements for those payment method options in the plurality of payment options that are not available to the customer for settlement.

5. The checkout device according to claim 4, wherein the non-selectable operation elements are displayed as grayed-out elements.

6. The checkout device according to claim 1, wherein the identifier value is a member ID corresponding to the customer.

7. The checkout device according to claim 1, wherein the identifier value is a medium identifier corresponding to a medium type used to input a member ID.

8. The checkout device according to claim 1, wherein the payment options available to the customer for settlement are acquired from a store server via a communication interface.

9. The checkout device according to claim 1, further comprising:
a storage unit, wherein
the payment options available to the customer for settlement are acquired from the storage unit.

10. A point-of-sale terminal for retail stores, the terminal comprising:
a storage unit;
a display unit configured to display information to a customer;
a scanner configured to read barcodes and commodity codes;
a card reader configured to read information from a card medium; and
a processor configured to:
acquire an identifier value identifying a customer in a sales transaction by member type;
acquire payment method options available to the customer for settlement of the sales transaction according to the identified member type for the customer;
cause the display unit to display a selection screen on which the acquired payment method options available to the customer are selectable;
receive a selection input of a payment method from among the selectable payment method options; and
use the selected payment method to perform settlement for items registered in the sales transaction using the scanner.

11. The point-of-sale terminal according to claim 10, wherein a plurality of payment method options for settlement of sales transactions are possible at point-of-sale terminal, but the payment method options available to customer for settlement of the sales transaction according to the identified member type is less than all of the plurality of payment method options.

12. The point-of-sale terminal according to claim 11, wherein the selection screen includes selectable operation elements for the acquired payment method options available to the customer.

13. The point-of-sale terminal according to claim 12, wherein the selection screen includes non-selectable operation elements for those payment method options in the plurality of payment options that are not available to the customer for settlement.

14. The point-of-sale terminal according to claim 13, wherein the non-selectable operation elements are displayed as grayed-out elements.

15. The point-of-sale terminal according to claim 10, wherein
the identifier value is a member ID corresponding to the customer, and
the member ID is acquired by the scanner or the card reader.

16. The point-of-sale terminal according to claim 10, wherein the identifier value is a medium identifier acquired when the scanner or the card reader is used to input a member ID.

17. The point-of-sale terminal according to claim 10, wherein the payment options available to the customer for settlement are acquired from a store server via a communication interface.

18. The point-of-sale terminal according to claim 10, wherein the payment options available to the customer for settlement are acquired from the storage unit.

19. A non-transitory, computer-readable medium storing program instructions which, when executed by a processor of a checkout device, cause the checkout device to perform a method comprising:
acquiring an identifier value identifying a customer by member type;
acquiring payment method options available to the customer for settlement of a sales transaction according to the identified member type;
causing a display unit to display a selection screen on which the acquired payment method options available to the customer are selectable;
receiving a selection input of a payment method from among the selectable payment method options; and
performing settlement using the selected payment method.

20. The non-transitory, computer-readable medium according to claim 19, wherein a plurality of payment method options for settlement of sales transactions are possible with the checkout device, but the payment method options available to customer for settlement of the sales transaction according to the identified member type is less than all of the plurality of payment method options.
